(19) United States
(12) Patent Application Publication
(10) Pub. No.: US 2022/0142125 A1
(43) Pub. Date: May 12, 2022

(54) RETRACTABLE DEVICE WITH AN INTERNAL LOCK

(71) Applicant: Chase Betzer, Austin, TX (US)

(72) Inventor: Chase Betzer, Austin, TX (US)

(21) Appl. No.: 17/645,819

(22) Filed: Dec. 23, 2021

Related U.S. Application Data
(60) Provisional application No. 63/198,500, filed on Oct. 23, 2020.

(51) Int. Cl. A01K 27/00

(52) U.S. Cl. CPC A01K 27/004; G09F 3/08

(57) ABSTRACT

A retractable leash assembly and system is provided. The leash assembly includes a button that operates an inner lock to selectively prevent and allow rotation of a reel upon which a leash winds on and off. The leash assembly is compact, can be held on a pet and is easily operable by the user. The leash assembly includes a housing which doubles as a handle for the user to grasp, as well as the structure in which the leash is retained.

### CROSS-REFERENCE TO RELATED APPLICATION

This application claims the benefit of priority of U.S. provisional application No. 63/198,500 filed Oct. 23, 2020, the contents of which are herein incorporated by reference.

### BACKGROUND OF THE INVENTION

The present invention relates to retractable devices and, more particularly, to wearable, retractable pet restraining devices.

A restraining device, such as a leash, is typically used for taking a pet into public places. It is also common for an owner to allow a pet to travel off the leash in areas that allow it, or in open spaces. However, in these circumstances, there is often a need for a leash in brief, unexpected moments. These circumstances either require an owner to carry a leash for the duration of the activity or restrain the pet by grabbing the collar or harness that is not ergonomic for either the pet or owner.

In private places, there are also times where a leash is not required by law but is needed due to a pet's behavior or guests being on a property. In these cases, a leash is often not readily available, and an owner will need to locate the leash and attach it to the pet before proceeding. It is also common that an owner will let go of a leash to let their pet travel on their own, leaving the pet to drag the leash with them; this is a risk for the pet to trip or get tangled.

Current Retractable leashes on the market are large and clunky focusing on increasing leash length, not reducing leash size. Non-retractable leashes offer no solution for the user to hold the leash when removed from the dog. Items on the market today offer little to no solution for what to do with a leash when not operating it with a pet. A standard leash is very simple and only focuses on constraining the pet or being cosmetically appealing.

As can be seen, there is a need for a wearable and retractable pet restraining device.

### SUMMARY OF THE INVENTION

In one aspect of the present invention, a retractable leash assembly comprises: a housing configured to be held by a user, in use; a reel rotatably mounted within the housing; a leash defining a first end configured to couple to a buckle and a second end that couples with the reel, the leash being movable between a retracted position and an extended position, with the housing and reel being dimensioned such that the leash wraps around the reel and is substantially retained in the housing in the retracted position; and a button movably disposed along an outer portion of the housing, the button being operable to selectively toggle the reel between: a locked state wherein the reel cannot rotate, and an unlocked state wherein the reel can rotate.

In certain embodiments, the button moves inwardly relative to the housing when toggling the reel to the unlocked state.

In certain embodiments, a compression spring is provided that biases the button outwardly relative to the housing to toggle the reel to the locked state.

In certain embodiments, the reel defines a plurality of cutouts, and the button comprises a lock rod coupled thereto, with the lock rod being configured to engage the reel within at least one of the cutouts in the locked state.

In certain embodiments, the lock rod does not engage any of the plurality of cutouts in the unlocked state.

In certain embodiments, a retraction spring is provided that is coupled to the reel, the retraction spring being configured to bias and rotate the reel to move the leash towards the retracted position.

In certain embodiments, the housing is substantially cylindrical in shape and the button is substantially axially aligned within the center of the housing.

In another aspect of the present invention, the retractable leash system comprises: a collar; a buckle that releasably couples with the collar; a retractable leash assembly comprising: a housing configured to be held by a user, in use; a reel rotatably mounted within the housing; a leash defining a first end coupled to the buckle and a second end that couples with the reel, the leash being movable between a retracted position and an extended position, with the housing and reel being dimensioned such that the leash wraps around the reel and is substantially retained in the housing in the retracted position; and a button movably disposed along an outer portion of the housing, the button being operable to selectively toggle the reel between: a locked state wherein the reel cannot rotate, and an unlocked state wherein the reel can rotate.

In certain embodiments, the retractable leash assembly further comprises one of a magnetic material and a magnet, and the collar comprises the other of the magnetic material and the magnet.

In certain embodiments, when the leash is in the retracted position, the retractable leash assembly is supported by the collar.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a front perspective view of an embodiment of the present invention, in use, attached to a pet's collar and fully retracted;

FIG. 2 is an exploded front perspective view of the embodiment of the present invention;

FIG. 3a is a side perspective view of the embodiment of the present invention, illustrating a potential storage solution for the embodiment on the pet's collar, with the embodiment in an uncoupled position;

FIG. 3b is a side perspective view of the embodiment of the present invention, illustrating the potential storage solution for the embodiment on the pet's collar of FIG. 3a, with the embodiment in a coupled position;

FIG. 4 is a detail cross-sectional view of the embodiment of the present invention, illustrating an internal locking mechanism thereof;

FIG. 5a is a rear perspective view of the embodiment of the present invention in a semi-assembled state, showing a retraction spring;

FIG. 5b is a rear elevation view of the embodiment of the present invention in a semi-assembled state, showing the retraction spring;

FIG. 5c is a rear perspective view of the embodiment of the present invention in a semi-assembled state, showing the leash coupled within a housing of the embodiment; and

FIG. 6 is a detail cross-sectional view of the embodiment of the present invention, showing a button of the embodiment depressed.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

The present invention allows a leash to be left on a pet at all times, serving as both an everyday leash, and an emergency leash. This greatly simplifies the process of restraining a pet. The size of the device is minimized for the comfort of the pet, while shaped ergonomically for the owner to hold. Advantageously, an auto lock has been integrated for the leash spool which ensures the device remains in its intended position, unless a user (e.g., the pet owner) intends to further elongate and or retract the device. The auto lock also protects against the leash coming loose during an entanglement or play with other pets. When the leash is needed the owner can easily extract the leash from the device. In addition to being worn at all times, this leash can be removed from the pet if needed, and its small form factor allows the owner to keep it in a personal pocket or purse.

Though embodiments of the present invention are small enough to be left on a pet's collar at all times, the user may wish to further constrain the device to keep it from swinging. To address this, a shim/plate (in certain embodiments, formed from steel or other ferromagnetic material) may be placed in the housing of the device to accommodate magnetic attraction. In other embodiments, an exterior portion of the housing may be formed from a ferromagnetic material.

In summary, the present invention provides a retractable mechanism inside an ergonomic housing that is to be used as the handle. The retracting reel is always biased to a locked position, requiring a user's depression of the button to enable retraction or extraction. The primary application is for an always-on dog leash solution but is applicable for other retractable device solutions as well.

In accordance with certain aspects of the present invention, embodiments described herein provide an effective method for housing a full-length leash in a compact and lightweight form factor to be left on a pet's collar for extended periods. The device contains a locking mechanism, which interacts with an inner circumference of the reel, allowing the outer form factor of the device to be minimized. The locking mechanism is biased to a locked state, requiring a user to depress a button to enable leash retraction/storage and extraction/extension. The button for the locking mechanism is advantageously placed in a location requiring dexterity to interact, making the device resistive to unintentional retraction such as playing with another pet or entangling with an object. The device is preferably made of corrosion-resistant materials to maintain strength and functionality after exposure to water and other liquids. The device may be attached to a pet's collar using a buckle or a clip mechanism, and the outer geometry of the device functionally serves as a handle for the user. An additional steel shim may be placed along a back wall of the device to constrain the device to a collar further. A magnet may be placed on the mating device for this feature to work. Finally, the device can be engraved, allowing it to function as a pet's identification tag or other custom markings as a user desires, as the device is designed to be pet-carried in regular use.

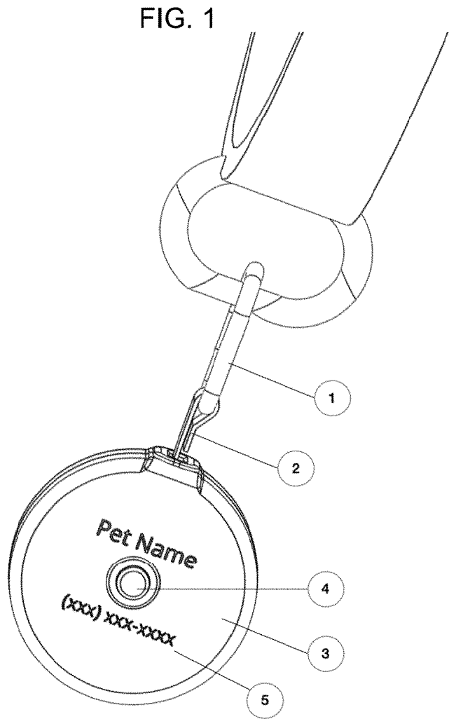

Referring now to FIGS. 1-5c, numerous specific details are set forth in the following description in order to provide a thorough understanding of the invention. However, the invention may be practiced according to the claims without some or all of these specific details. For the purpose of clarity, technical material that is known in the technical fields related to the present invention has not been described in detail so that the present invention is not unnecessarily obscured.

FIG. 1 illustrates the device with the leash fully retracted. The device is attached to an animal's collar 32 using a buckle or clip 1. The clip 1 is attached to the internal leash component 2, which may be, in certain embodiments, made of webbing (with material such as, but not limited to, Nylon/Polyester/Polypropylene), rope, or wire. The external housing 3 of the device serves three main functions. First, the external housing 3 houses the device's internal components (as described in greater detail below). Second, it provides an ergonomic handle for the owner. Third, it provides a surface that can be engraved with dog identification features 5 (such as a pet owner's phone number or the pet's name). The external housing 3 may be substantially cylindrical in certain preferred embodiments, but may be modified in other embodiments to other ergonomically shaped designs. In certain embodiments, the external housing 3 of the device may be made of either corrosion-resistant metals or plastic. Coatings may also be applied to the device to improve how it feels in the user's hands and provide an arrangement of colors. The device is intended to have an outer diameter of less than 3 inches to comfortably fit in a user's hand and not be too bulky when left on a pet's collar. However, in other embodiments, a larger size can be used for other device applications.

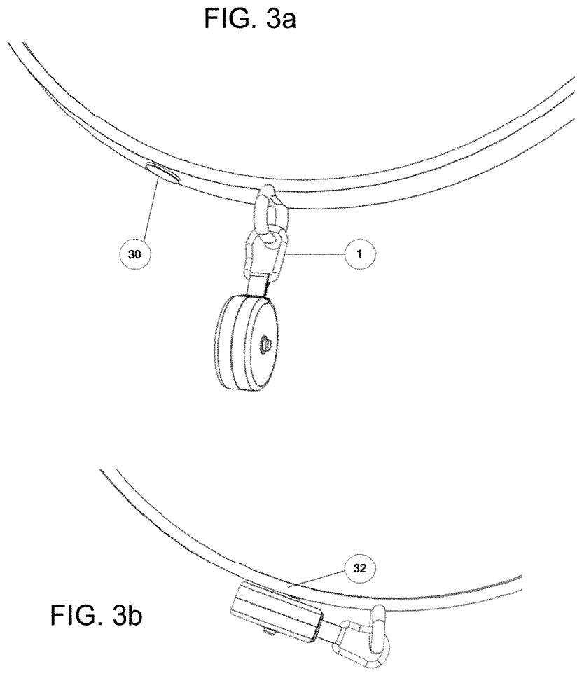

At the center of housing 3, running through the cylinder's axis, is the button 4 of the locking mechanism. This button 4 is intentionally kept to a smaller size to require a user's finger dexterity to activate and thus avoids activation from another pet during a time of play. As shown in FIG. 3, the button protrudes from the housing at a distance adequate to fully disengage the lock once pressed near flush with the housing surface. Additional details of this lock will be explained in greater detail below.

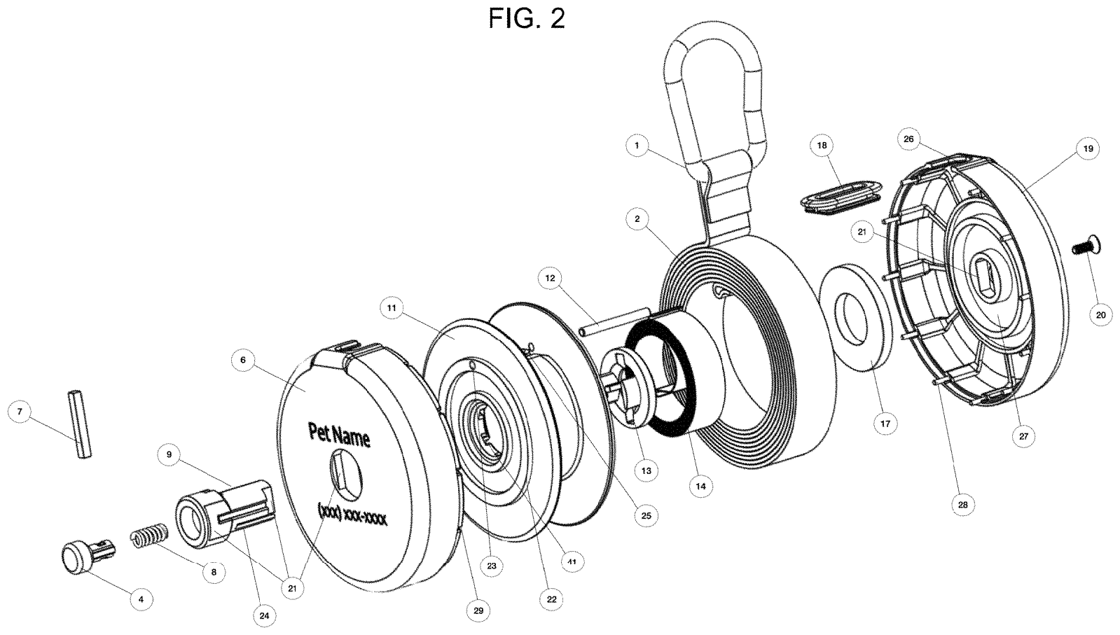

FIG. 2 illustrates an exploded view of the device and components within. Starting from the left side of FIG. 2 and working toward the right, the following is a general description of each part and its interactions. A button 4 is provided, which the user may interact with to unlock the spool/reel's rotation. A lock rod 7 is provided, which may interact with the button 4, an internal hub 9, and a reel 11. A compression spring 8 is provided, which biases the button 4 and lock rod 7 to a locked state. An internal hub 9 is provided, which is the primary mounting point for most components and is also the axis of rotation for the reel 11. A front housing 10 is provided, which functions as the cosmetic outer surface and defines a portion of the overall container for internal components. A reel or spool 11 is provided, which rotates on the internal hub 9 and stores the retracted webbing 2 or wire. A dowel pin 12 is provided, which serves as the connection point between the reel 11 and webbing 2. An internal plate 13 is provided, which separates the internal lock mechanism from the retraction spring 14. A retraction spring 14 is provided, which helps to wind the leash 2 into the housing 3. A leash/webbing/wire 2 is provided, which is coiled around the reel/spool 11. A buckle/clip 1 is provided, which connects the retraction mechanism to a desired object. An internal steel plate 17 is provided, which allows the device to interact with magnetic objects. An eyelet 18 is provided, which connects the two housing components 10, 19 and provides a smooth sliding point for the webbing exit. A rear housing 19 is provided, which is the cosmetic outer surface and container for internal components. A screw/bolt 20 (or another fastener) is provided, which holds the two housings 10, 19 together to seal internal components

The components may be made of both corrosion-resistant metals and plastics, depending on the specific function, strength requirements, and weight. The internal hub 9 serves as the primary mounting surface and as the axis of rotation for the reel. Inside this keyed rod will be the compression spring 8, which provides a force to the button 6 and the locking rod 7. The locking rod 7 engages with the reel 11 with the force applied from the compression spring. This internal hub 9 also provides a cylindrical surface for which the reel 11 can rotate. The internal hub 9 further provides a mounting surface for the housings 10, 19, and the internal plate 13, which are limited from rotation due to the keyed surfaces 21 on the exterior of the internal hub. The internal plate 13 provides a physical separation for the locking mechanism and the retraction spring 14, which share the space inside the inner diameter of the reel 11. The reel 11 may be provided with areas of increased thickness or ribs 22, which provide a limited surface area to contact the housing. These features reduce the total amount of friction between the reel 11 and housing 10,19 from compression forces applied by screw/fastener 20. Parts throughout the assembly are also toleranced to avoid excessive compression on the reel 11, with the distance inside the housings 10, 19 being slightly larger than the width of the reel itself. Additionally, the reel contains through holes 23, which allow a dowel pin 12 to travel through, enabling a connection point for the leash 2 to the reel 11.

The reel's retraction force is provided by the retraction spring 14, which connects to the internal hub's slotted feature 24, as well as the reel's slotted feature 25. The inner diameter of the reel and the outer diameter of the hub are designed such that the retraction spring 14 can provide a retractable force for the entire length of leash.

Both housing parts 10, 19 have internal ribs that interact with the reel 11 as mentioned above, which provide additional stiffness and the ability to interact with other componentry. Both housings have a slotted opening allowing the eyelet to connect the two parts 26. The rear housing 19 specifically may be provided with a cutout 27, allowing the internal steel plate 17 to be assembled using glue or another adhesive. Additionally, the rear housing has external pegs 28, which mate with holes on the front housing 29. Since the only mounting feature is the screw 20, additional coupling is needed at the circumference of the housing to keep it cosmetically sealed. These external pegs 28, 29 provide coupling at the outer circumference of the housings and an internal glue dispensing area that cannot be seen from the outside of embodiments of the present invention.

Referring now to FIGS. 3a and 3b, as mentioned previously, the assembly may contain an internal steel plate 17, which allows the device to be further constrained using an external magnet. FIG. 3a shows an example of a magnet 30 placed on the outside of a pet's collar 32, allowing the device to be held to the collar through two contact points (see FIG. 3b). Contact point one that will be the primary contact point is the buckle or clip 1 component detailed above, which connects the device to a pet's collar or other object and will remain intact whether the leash is in a retracted or extracted state. The secondary contact point is optional to the user, and not required for the disclosed embodiments of the retraction device to operate. This secondary connection point requires a magnet to be placed on the external object 32 which the user wants the retraction device to mount to. With this magnet placed on an external object, the device can be further constrained to be kept from swinging.

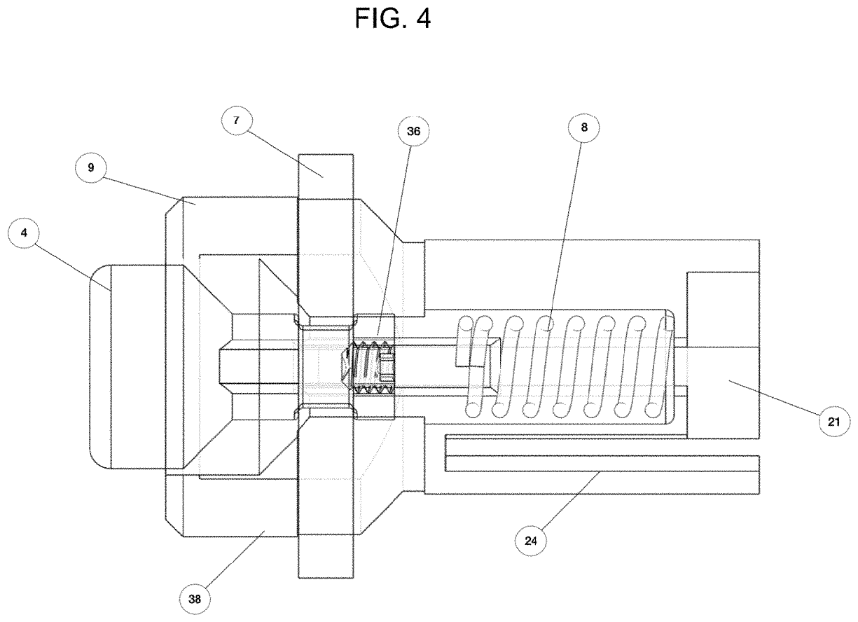

Referring now to FIG. 4, the internal lock includes, but is not limited to, the internal hub 9, the button 4, the locking rod 7, a set screw 36, and a compression spring 8. The flat surfaces of the internal hub 38, 21 interact with the housings to fix them from rotation. The internal hub 9 is hollow, allowing the button 33 and compression spring 8 to be housed within. A slot in the internal hub allows the lock rod 7 to be assembled and travel in the left and right direction based on the illustrated orientation. The lock rod is assembled into the cutout of the button 33 and kept in place with a set screw 36.

The lock rod 7 will be able to move left and right, in the pictured orientation of FIG. 4, which toggles between a locked state (left) to an unlocked state (right). With the force of the compression spring 8, the lock rod 7 will be biased to the left side, and at this state the lock rod will engage with internal cutouts in the reel (see FIG. 2—callout 41). This will limit the reel 11 from rotation which locks the webbing 2 or wire contained on the leash from being extracted or retracted. When a user depresses the button 33, the lock rod 7 will no longer engage with the internal cutouts of the reel 11, enabling rotation. The reel's rotation is then subject to retraction force from the retraction spring 14, which installs to the slotted cutout of the internal hub 24. This retraction force causes the leash 2 to be retracted into the reel 11. A user can overcome the retraction spring's force to enable the webbing 2 or wire to be extracted from the reel 11. At any point, if a user disengages the button 33, the device may return to the locked state, and the reel 11 will no longer be capable of extracting or retracting webbing 2 or wire.

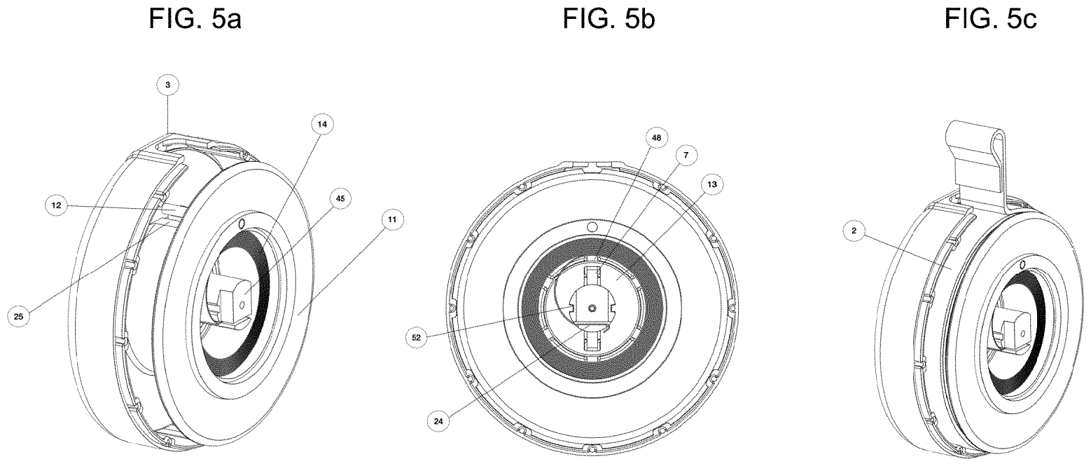

Referring now to FIGS. 5a-5c, as mentioned above, the internal locking mechanism 45 will interact with the front housing 10, reel 11, and retraction spring 14. The retraction spring 14 engages between the internal hub slotted cutout 24 and the reel's slotted cutout 25. The device is designed to always be biased to locked state, with the lock rod 7 engaged with the reel's internal cutouts 48. This engagement will keep the reel 11 from rotating, keeping the wire or webbing 2 from being extracted or retracted. The lock mechanism 45 is separated from the retraction spring 14 by the internal plate 13, which is assembled to the internal hub using keyed features 52. Once the button is depressed, as described before, the lock rod 7 will no longer engage with the reel 11, allowing extraction or retraction of wire or webbing 2 from the reel 11. The wire or webbing is connected to the reel using a dowel pin 12, which is press-fit into the reel 11. The wire or webbing 2 may then be coiled around the reel to contain its entire length.

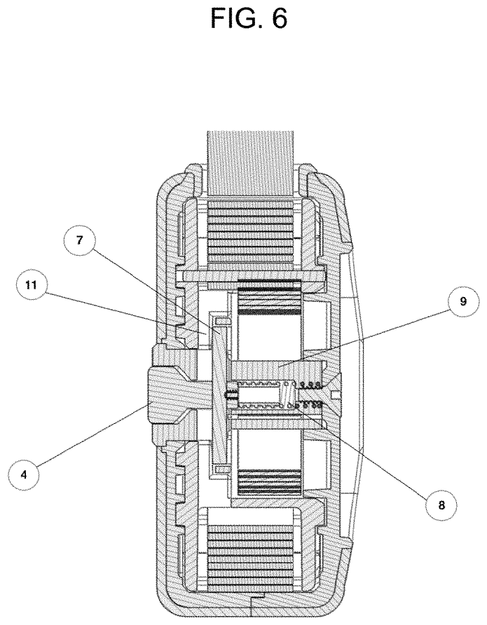

Referring now to FIG. 6, a cross section view of the assembly can be seen with the button 4 in depressed state. When the button 4 is depressed, it causes a translation of the lock rod 7 in the internal hub 9, eventually clearing the reel 11 allowing for rotation. Additionally, the compression spring 8 will be compressed within the internal hub 9 providing the force necessary for the lock to re engage once the user releases the button.

Methods of making and using embodiments of the present invention would be readily apparent to those with skill in the art from the foregoing description. The components should be manufactured and assembled as described above. Further, the present invention may be used in ways described above, where the button is pressed to retract and extend the leash from the housing selectively. When the leash is extended, the housing may be used as a handle, and when the leash is retracted, the pet may carry the housing on its leash due to its compact and lightweight dimensioning.

Although a number of modifications may be made that are in the spirit of the present invention, a few will be described herein (in addition to others described above) that would further allow for applications in other industries. The present invention stores the reel locking mechanism inside the reel, but similarly, the outer diameter of the reel could be used. Further, the mechanical button could be replaced with an electrical actuation for use in other industries which have limited operator interaction. Finally, the assembly housing may be modified to be mounted to objects, allowing the mechanism to be used with more permanent structures.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A retractable leash assembly comprising:
a housing configured to be held by a user, in use;
a reel rotatably mounted within the housing;
a leash defining a first end configured to couple to a buckle and a second end that couples with the reel, the leash being movable between a retracted position and an extended position, with the housing and reel being dimensioned such that the leash wraps around the reel and is substantially retained in the housing in the retracted position; and
a button movably disposed along an outer portion of the housing, the button being operable to selectively toggle the reel between:
a locked state wherein the reel cannot rotate, and
an unlocked state wherein the reel can rotate.

2. The retractable assembly of claim 1, wherein the button moves inwardly relative to the housing when toggling the reel to the unlocked state.

3. The retractable assembly of claim 2, further comprising:
a compression spring biasing the button outwardly relative to the housing to toggle the reel to the locked state.

4. The retractable assembly of claim 1, wherein the reel defines a plurality of cutouts, and the button comprises a lock rod coupled thereto, with the lock rod being configured to engage the reel within at least one of the cutouts in the locked state.

5. The retractable assembly of claim 4, wherein the lock rod does not engage any of the plurality of cutouts in the unlocked state.

6. The retractable assembly of claim 1, further comprising a retraction spring coupled to the reel, the retraction spring being configured to bias and rotate the reel to move the leash towards the retracted position.

7. The retractable assembly of claim 1, wherein the housing is substantially cylindrical in shape and the button is substantially axially aligned with a center of the housing.

8. A retractable leash system comprising:
a collar;
a buckle that releasably couples with the collar;
a retractable leash assembly comprising:
a housing configured to be held by a user, in use;
a reel rotatably mounted within the housing;
a leash defining a first end coupled to the buckle and a second end that couples with the reel, the leash being movable between a retracted position and an extended position, with the housing and reel being dimensioned such that the leash wraps around the reel and is substantially retained in the housing in the retracted position; and
a button movably disposed along an outer portion of the housing, the button being operable to selectively toggle the reel between:
a locked state wherein the reel cannot rotate, and
an unlocked state wherein the reel can rotate.

9. The retractable leash system of claim 8, wherein the retractable leash assembly further comprises one of a magnetic material and a magnet, and the collar comprises the other of the magnetic material and the magnet.

10. The retractable leash system of claim 8, wherein, when the leash is in the retracted position, the retractable leash assembly is supported by the collar.
